(19) United States
(12) Patent Application Publication
(10) Pub. No.: US 2013/0271267 A1
(43) Pub. Date: Oct. 17, 2013

(54) APPARATUS FOR ENCODING RFID TAG

(71) Applicant: LSIS CO., LTD., Anyang-si (KR)

(72) Inventor: Kirock KIM, Cheonan-si (KR)

(73) Assignee: LSIS CO., LTD., Anyang-si (KR)

(21) Appl. No.: 13/857,823

(22) Filed: Apr. 5, 2013

(30) Foreign Application Priority Data
Apr. 13, 2012 (KR) 10-2012-0038468

(51) Int. Cl. G06K 7/10

(52) U.S. Cl. CPC G06K 7/10009
USPC 340/10.3

(57) ABSTRACT

An apparatus for encoding RFID tag is disclosed, the apparatus including an RFID reader managing an encoding section for encoding tag information on a tag in a case a trigger signal is received from a PLC and an inspection section for inspecting the encoded tag information, whereby productivity can be enhanced and a high speed encoding can be realized.

### CROSS-REFERENCE TO RELATED APPLICATION

Pursuant to 35 U.S.C.§119 (a), this application claims the benefit of earlier filing date and right of priority to Korean Patent Application No.10-2012-0038468, filed on Apr. 13, 2012, the contents of which are hereby incorporated by reference in their entirety.

### BACKGROUND OF THE DISCLOSURE

1. Field of Invention

The present disclosure relates to an apparatus for encoding RFID (Radio Frequency Identification) tag.

2. Description of Related Art

This section is intended to introduce the reader to various aspects of art that may be related to various aspects of the present disclosure that are described or claimed below. This discussion is believed to be helpful in providing the reader with background information to facilitate a better understanding of the various aspects of the present disclosure. Accordingly, it should be understood that these statements are to be read in this light and not as admissions of prior art.

Generally, packing containers are attached with bar codes or bar code stickers to enable an easy identification of products, but the bar code system suffers from disadvantages in that information can be obtained by contact with the products.

In order to overcome this disadvantage of the bar code system, products replacing the bar codes with RFID tags are continuously developed one after another.

Generally, an RFID (Radio Frequency Identification) technique is a technique for identifying a data carrier by using a radio wave without contact. With this technique, an “IC chip and an antenna-embedded” tag (RFID tag) is attached to an object or a person, a device called an RFID reader/writer, and the RFID tag makes a communication by using a radio wave, and the RFID reader/writer reads information stored in the IC chip (RFID tag IC), whereby the object or the person is identified.

That is, the (RFID) tags are electronic devices that may be affixed to items whose presence is to be detected and/or monitored. To be more specific, the RFID system employs an RFID tag that is attached to a product to transmit detailed information, and an RFID transmitter/receiver capable of reading identification information stored in the RFID tag using an RF communication. The RFID tag transmits information using radio frequency communication by passing through an area positioned with the transmitter/receiver to provide a base for an effective control on logistics/distribution such as product distribution, assembly, price change, security, environmental control, safety and marketing, to name a few.

Methods for encoding tag information desired by a user from an RFID tag may include individual encoding of individual tag using a fixed reader, continuous encoding and inspection of RFID tags on a conveyor by individually mounting an antenna for encoding and an antenna for inspection on the conveyor, and printing tag information by temporarily stopping an individual tag of a loaded tag roll when the individual tag reaches a predetermined position using an RFID printer. However, the conventional encoding methods suffer from disadvantages in that productivity decreases due to manual work of individual tags, a plurality of antennas is required, and encoding speed decreases due to temporary stop of the individual tags on a tag roll during encoding.

### SUMMARY OF THE DISCLOSURE

The present disclosure is disclosed to obviate the above-mentioned disadvantages, and to provide an apparatus for encoding RFID (Radio Frequency Identification) tags configured to perform encoding and inspection of RFID tags using a signal antenna with a predetermined tag identification range during the tags being continuously moved.

Furthermore, the present disclosure is to provide an apparatus for encoding RFID tags configured to perform an encoding and inspection while a dielectric substance is attached to a bottom surface of an RFID tag.

In one general aspect of the present disclosure, there is provided an apparatus for encoding RFID tags, the apparatus comprising:
a tag detection sensor detecting a position of a tag arranged on a tag roll;
a PLC (Programmable Logic Controller) generating a trigger signal while the tag detection sensor detects the position of the tag;
an RFID reader encoding tag information of the tag in a case the trigger signal is received from the PLC, and inspecting information encoded on the tag;
an antenna transmitting the signal received from the RFID reader and receiving the signal from the tag according to a variably-set tag identification range; and
a panel oppositely formed from the antenna and spaced apart from the antenna at a predetermined distance, and contacting one surface of the tag within the tag identification range.

In some exemplary embodiments, the tag detection sensor may detect the position of the tag using a gap between each tag of the tag roll.

In some exemplary embodiments, the tag detection sensor may detect the position of the tag using an identification mark printed between each tag of the tag roll.

In some exemplary embodiments, the apparatus may further comprise a shield unit formed at one surface of the antenna and variable in size of an opening to allow the antenna to transmit and receive the signal within the tag identification range.

In some exemplary embodiments, the apparatus may further comprise a dielectric substance formed oppositely from the panel and spaced apart from the panel as much as a thickness of the tag to contact the other surface of the tag within the tag identification range.

In some exemplary embodiments, the apparatus may further comprise a printing unit formed on a transfer path of the tag to print additional information on the tag.

In some exemplary embodiments, the antenna may be a single antenna configured to perform an encoding and inspection of the tag information.

In some exemplary embodiments, the RFID reader may perform the encoding by transmitting the tag information (first tag information) to the tag through the antenna at a first section.

In some exemplary embodiments, the RFID reader may perform the encoding by transmitting the tag information (second tag information) to the tag through the antenna at a second section.

In some exemplary embodiments, the RFID reader may determine that the RFID tag is normal, in a case the first tag information and the second tag information are same.

In an advantageous effect, the apparatus for encoding an RFID tag according to exemplary embodiments of the present disclosure can detect a position of an individual tag arranged on a tag roll during continuous movement of the tag and perform an tag information encoding and inspection using a single antenna, in a case the individual tag is positioned at a predetermined tag identification range, whereby productivity can be improved and a high speed encoding can be enabled.

In another advantageous effect, the apparatus for encoding an RFID tag according to exemplary embodiments of the present disclosure can perform an encoding and inspection of tag information under a state analogous to an environment a tag is actually used by allowing a dielectric substance having a predetermined permittivity to contact a bottom surface of the tag.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description, serve to explain the principle of the disclosure. In the drawings:

FIG. 1 is a schematic view illustrating an apparatus for encoding an RFID tag according to an exemplary embodiment of the present disclosure;

FIG. 2 is a schematic view illustrating a tag roll applied to an apparatus for encoding an RFID tag according to an exemplary embodiment of the present disclosure; and

FIG. 3 is a flowchart illustrating an operation process of an apparatus for encoding an RFID tag according to an exemplary embodiment of the present disclosure.

### DETAILED DESCRIPTION

The disclosed embodiments and advantages thereof are best understood by referring to the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments, and protected by the accompanying drawings. Further, the illustrated figures are only exemplary and not intended to assert or imply any limitation with regard to the environment, architecture, or process in which different embodiments may be implemented. Accordingly, the described aspect is intended to embrace all such alterations, modifications, and variations that fall within the scope and novel idea of the present invention.

Now, exemplary embodiments of the present disclosure will be described in detail with reference to the accompanying drawings.

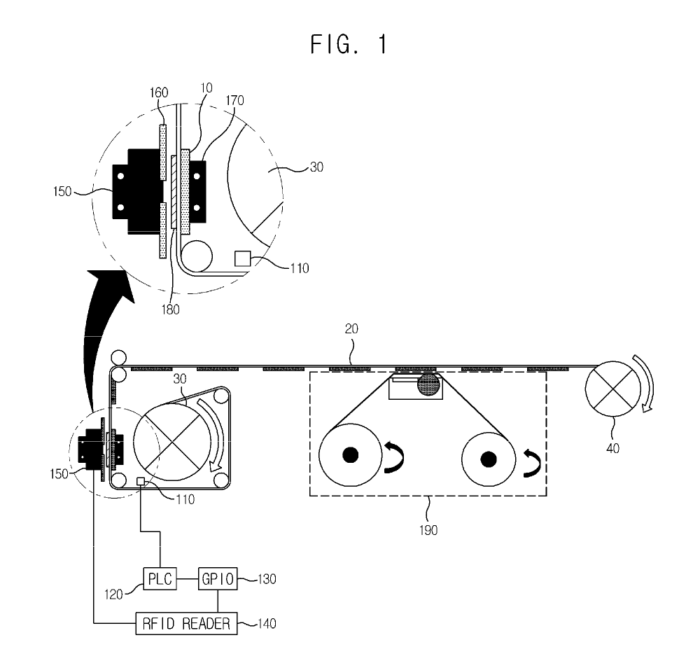

FIG. 1 is a schematic view illustrating an apparatus for encoding an RFID tag according to an exemplary embodiment of the present disclosure.

The apparatus for encoding an RFID tag according to an exemplary embodiment of the present disclosure uses a tag roll 20 wound by a plurality of tags 10 in a roll type. Furthermore, before the tag roll 20 loaded on an unwinder 30 is rewound in a roll type on a rewinder 40 through a tag transfer path, an encoding and inspection may be performed on an individual tag by the apparatus for encoding RFID tag according to an exemplary embodiment of the present disclosure.

Referring to FIG. 1, the apparatus for encoding the RFID tag according to an exemplary embodiment of the present disclosure includes a tag detection sensor 110, a PLC (Programmable Logic Controller, 120), a GPIO (General Purpose Input Output, 130), an RFID reader 140, an antenna 150, a shield unit 160, a panel 170 and a dielectric substance 180.

The tag detection sensor 110 detects each position of tags arranged on the tag roll 20 and transmits a detection signal to the PLC 120. The tag detection sensor 110 may detect the position of individual tag using a predetermined mark formed on the tag roll 20.

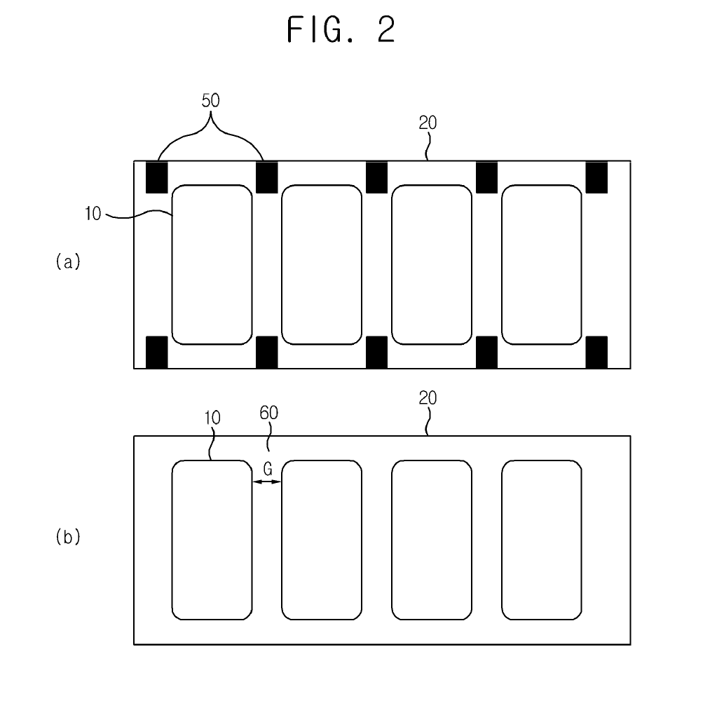

Now, referring to FIG. 2 (a), the tag detection sensor 110 may detect the position of individual tag 10 using an identification mark 50 printed between each tag 10 mounted on the tag roll 20, or referring to FIG. 2 (b), the tag detection sensor 110 may detect the position of individual tag 10 using a gap (G, 60) between each tag 10 mounted on the tag roll 20.

The PLC 120 has an overall control over the apparatus for encoding the RFID tag according to an exemplary embodiment of the present disclosure. In a case a detection signal is received from the tag detection sensor 110, the PLC 120 transmits a trigger signal to the RFID reader 140 through the GPIO 130. Furthermore, the PLC 120 receives information on an encoding process status and an inspection result from the RFID reader 140 while the encoding and inspection are performed on the tags 10, and displays the information on a display device (not shown) to allow a user to review the information.

The GPIO 130 serves as an interface between the PLC 120 and the RFID reader 140. The PLC 120 and the RFID reader 140 may exchange signals through the GPIO 130. The RFID reader 140 receives a trigger signal transmitted from the PLC 120 through the GPIO 130. In a case the trigger signal is received, the RFID reader 140 performs the encoding and the inspection for a predetermined period of time. At this time, the predetermined period of time includes an encoding section and an inspection section, and is so set up as to allow the encoding and the inspection to be performed while the tag 10 is being transferred.

The RFID reader 140 encodes the tag information by transmitting the tag information via the antenna 150 at the encoding section. The RFID reader 140 receives the tag information encoded from the tag 10 at the inspection section, and compares if the tag information transmitted from the tag 10 matches the tag information transmitted to the tag 10 at the encoding section.

The RFID reader determines that the RFID tag is normal, in a case the first tag information and the second tag information are same or matched as a result of the comparison, and determines that the RFID tag is abnormal or bad, in a case the first tag information and the second tag information are same or matched as a result of the comparison. The RFID reader 140 transmits the normal or abnormal inspection result to the PLC 120 through the GPIO 130. The PLC 120 may provide the inspection result received from the RFID reader 140 through the GPIO 130 to a user via a display unit (not shown).

The predetermined period of time for performing the encoding and the inspection on the tag 10 is progressed in a case the RFID reader 140 receives the trigger signal. Whenever the tag detection sensor 110 detects each tag 10 arranged on the tag roll 20, the PLC 120 may generate a trigger signal and the RFID reader 140 may perform the encoding and inspection processes on each tag 10 in response to the trigger signal.

The antenna 150 is formed on a tag transfer path, transmits a signal provided from the RFID reader 140 within a tag identification range and receives the signal from the tag 10. That is, the antenna 150 transmits the tag information provided from the RFID reader 140 at the encoding section to the tag 10, receives the tag information from the tag 10 at the inspection section, and transmits the tag information to the RFID reader 140. Furthermore, the antenna 150 may be formed in a single antenna configured to simultaneously perform the encoding of the tag information and the inspection of the tag information.

The shield unit 160 is formed at one surface (i.e., a radiation surface from which a signal is emitted) of the antenna 150, and is formed with an opening to allow the antenna to transmit or receive a signal within a tag identification range. At this time, the tag identification range is a scope in which a signal having an appropriate size and directivity can be emitted through the antenna 150 to allow the tag information to be encoded without causing any error on the individual tag 10.

The tag identification range may be differently set up depending on a pitch of the tag 10 arranged on the tag roll 20 and a moving speed of the tag roll 20, and it is preferable that the opening be variably formed in size. The antenna 150 can receive and transmit a signal through the opening, such that the size of the opening is changed in response to changes in the tag identification range, whereby the antenna 150 can individually transmit a signal to or receive the signal from the each individual tag 10 without any interference from other tags.

Meantime, the tag identification range may be set up with a time limit added thereto, and the tag identification range may be set up in such a manner that a signal is emitted through the antenna 150 within the tag identification range after the RFID reader 140 receives the trigger signal from the PLC 120 and the tag roll 20 moves at a predetermined length, for example.

The panel 170 is formed on the tag transfer path in response to the tag identification range. The panel 170 is arranged oppositely formed from the antenna 150, being spaced apart at a predetermined distance. The tag roll 20, to be more specific, each tag 10 is transferred, being in contact with one surface of the panel 170 opposite to the antenna 150, and goes through the encoding and inspection processes by the RFID reader 140, in a case the tag 10 is brought into contact with the one surface of the panel 170.

The dielectric substance 180 having a predetermined permittivity is oppositely formed from the panel 170 and distanced as much as a thickness of the tag 10, whereby the tag 10 is transferred, while being contacted between the panel 170 and the dielectric substance within the tag identification range.

Hence, the encoding and inspection processes are performed by the RFID reader 140 while an upper surface and a bottom surface of the tag 10 are brought into contact with the panel 170 and the dielectric substance 180. The permittivity of the dielectric substance 180 may be determined in consideration of permittivity of an article to be actually attached with the tag 10, and as a result, the tag information encoding is performed under a state analogous to an actual use environment of the tag 10 attached to a predetermined article, whereby an encoding error can be reduced.

A printing unit 190 is formed at an upper surface of the tag 10 moving along the tag transfer path to print on a surface of the tag 10 additional information including tag information, a text, a bar code and an image. Although FIG. 1 has illustrated a carbon ribbon as an example of the printing unit 190, an ink jet printer may be used in addition to the carbon ribbon.

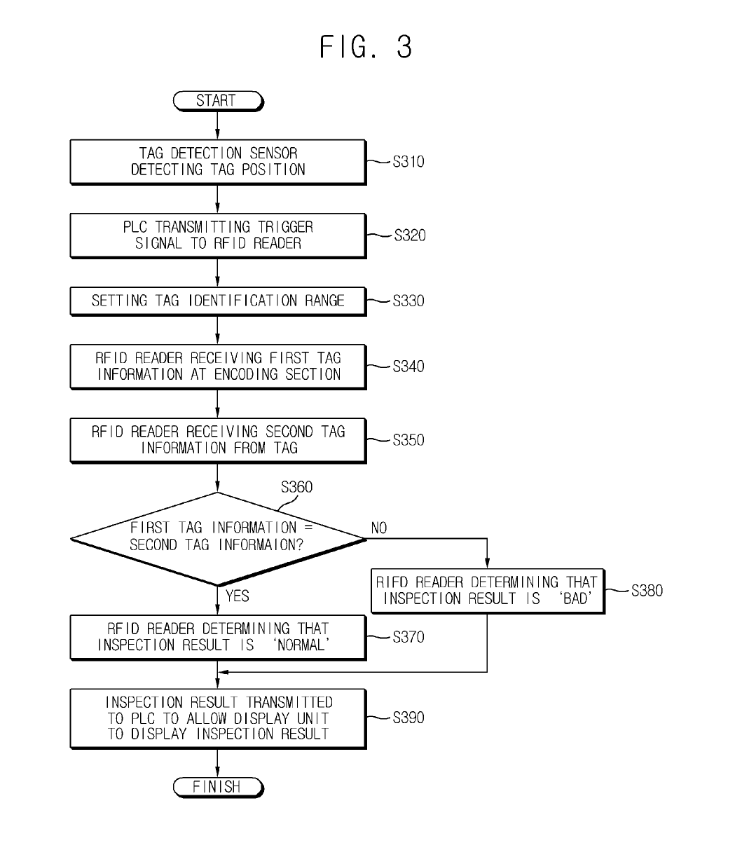

Now, an operation process of an apparatus thus configured for encoding an RFID tag according to an exemplary embodiment of the present disclosure will be described in detail with reference to FIG. 3.

FIG. 3 is a flowchart illustrating an operation process of an apparatus for encoding an RFID tag according to an exemplary embodiment of the present disclosure.

Referring to FIG. 3, in a case the tag roll 20 is loaded on the unwinder 30 of the apparatus for encoding the RFID tag according to an exemplary embodiment of the present disclosure and the tag transfer is started, the tag detection sensor 110 detects the position of each tag 10 arranged on the tag roll 20 (S310). The tag detection sensor 110 can detect the position of each individual tag 10 by using the identification mark 50 printed between each tag 10 arranged on the tag roll 20 or the gap (G, 60) between each tag 10. In a case the tag detection sensor 110 detects the position of tags to provide a detection signal to the PLC 120, the PLC 120 transmits the trigger signal to the RFID reader 140 (S320).

Successively, the tag identification range is set up (S330). The tag identification range may be set up by spatial limit and time limit. The spatial limit is set up by position of the antenna 150 and the panel 170, and position of opening formed on the shield unit 160. That is, the tag identification range may be initially set up in response to position of the antenna 150 and the panel 170 each oppositely formed and spaced apart at a predetermined distance. Then, the initially set tag identification range may be additionally changed by adjusting the size and directivity of a signal emitted from the antenna 150 and by varying the size of the opening of the shield unit 160 formed on a radiation surface of the antenna 150.

At this time, the time limit may be set by being added to the spatial limit. By way of non-limiting example, the setting may be such that a signal for encoding is emitted from the antenna 150 after the tag roll 20 moves for a predetermined period of time or as much as a predetermined length from a point on which the trigger signal is received from the PLC 120. The tag identification range may be set up by a pitch of the tag 10 arranged on the tag roll 20 or moving speed of the tag roll 20.

In a case the trigger signal is received from the PLC 120 at step S320, the RFID reader 140 performs the tag information encoding and inspection for a predetermined period of time. The predetermined period of time includes an encoding section and an inspection section, where the predetermined period of time is progressed whenever the tag detection sensor 110 detects the position of each tag 10 arranged on the tag roll 20.

The RFID reader 140 transmits (S340) first tag information through the antenna 150 at the encoding section, in a case the individual tag 10 arranged on the tag roll 20 is positioned at a tag identification range set up at the step S330. In a case the tag 10 is positioned within the tag identification range, the tag 10 is brought into contact with the panel 170 formed at the tag identification range, where the dielectric substance 180 having a predetermined permittivity may be formed at a bottom surface of the tag 10. In this case, as the bottom surface of the tag 10 is brought into contact with the dielectric substance, the tag information encoding is performed under a state analogous to an actual use environment of the tag 10 attached to a predetermined article, whereby an encoding error can be reduced.

In a case the encoding section is finished, the inspection section is continuously progressed. The RFID reader 140 receives (S350) currently encoded second tag information from a relevant tag 10 that has transmitted the first tag information at step S340. The RFID reader 140 determines whether the first tag information and the second tag information are same or matched at the inspection section (S360).

The RFID reader determines that the RFID tag is normal (S370), in a case the first tag information and the second tag information are same or matched as a result of determination at step S360, and determines that the RFID tag is not normal (bad) (S380), in a case the first tag information and the second tag information are not same or matched as a result of determination at step S360.

The RFID reader 140 transmits the inspection results at S370 and S380 to the PLC 120, where the PLC 120 displays the inspection result on a display unit for use by a user (S390).

Meanwhile, the steps of S310 to S390 are repeatedly conducted whenever the tag detection sensor 110 detects the individual tag 10 arranged on the tag roll 20. That is, whenever the tag detection sensor 110 detects each tag 10 moving along the tag transfer path, the PLC 120 generates a trigger signal, whereby the RFID reader 140 can perform the encoding and inspection processes on the each tag 10 in response to the trigger signal.

What has been described above includes examples of one or more aspects. It is, of course, not possible to describe every conceivable combination of components or methodologies for purposes of describing the aforementioned aspects, but one of ordinary skill in the art may recognize that many further combinations and permutations of various aspects are possible. Accordingly, the described aspects are intended to embrace all such alterations, modifications, and variations that fall within the scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An apparatus for encoding RFID tags, the apparatus comprising:
a tag detection sensor detecting a position of a tag arranged on a tag roll;
a PLC (Programmable Logic Controller) generating a trigger signal while the tag detection sensor detects the position of the tag;
an RFID reader encoding tag information of the tag in a case the trigger signal is received from the PLC, and inspecting information encoded on the tag;
an antenna transmitting the signal received from the RFID reader and receiving the signal from the tag according to a variably-set tag identification range; and
a panel oppositely formed from the antenna and spaced apart from the antenna at a predetermined distance, and contacting one surface of the tag within the tag identification range.

2. The apparatus of claim 1, wherein the tag detection sensor detects the position of the tag using a gap between each tag of the tag roll.

3. The apparatus of claim 1, wherein the tag detection sensor detects the position of the tag using an identification mark printed between each tag of the tag roll.

4. The apparatus of claim 1, further comprising a shield unit formed at one surface of the antenna and variable in size of an opening to allow the antenna to transmit and receive the signal within the tag identification range.

5. The apparatus of claim 1, further comprising a dielectric substance formed oppositely from the panel and spaced apart from the panel as much as a thickness of the tag to contact the other surface of the tag within the tag identification range.

6. The apparatus of claim 1, further comprising a printing unit formed on a transfer path of the tag to print additional information on the tag.

7. The apparatus of claim 1, wherein the antenna is a single antenna configured to perform an encoding and inspection of the tag information.

8. The apparatus of claim 1, wherein the RFID reader performs the encoding by transmitting the tag information (first tag information) to the tag through the antenna at a first section.

9. The apparatus of claim 8, wherein the RFID reader performs the encoding by transmitting the tag information (second tag information) to the tag through the antenna at a second section.

10. The apparatus of claim 9, wherein the RFID reader determines that the RFID tag is normal, in a case the first tag information and the second tag information are same.
